(19) United States
(12) Patent Application Publication
(10) Pub. No.: US 2017/0136577 A1
(43) Pub. Date: May 18, 2017

(54) Method for Welding a Ball onto a First Component, and Method for Connecting Two Components

(71) Applicant: Bayerische Motoren Werke Aktiengesellschaft, Muenchen (DE)

(72) Inventor: Johann VAN NIEKERK, Muenchen (DE)

(21) Appl. No.: 15/421,674

(22) Filed: Feb. 1, 2017

Related U.S. Application Data
(63) Continuation of application No. PCT/EP2015/068744, filed on Aug. 14, 2015.

(30) Foreign Application Priority Data
Sep. 22, 2014 (DE) 10 2014 218 968.3

(51) Int. Cl. B23K 26/22; B29C 65/00; B29C 65/16; B29C 65/78; B23K 26/382; B23K 26/60

(52) U.S. Cl. CPC B23K 26/22; B23K 26/382; B23K 26/60; B29C 65/16; B29C 65/7808; B29C 65/7817; B29C 66/474; B29C 66/721

(57) ABSTRACT

A method for welding a ball onto a first component includes the following steps: providing a first component; creating a physical mark in or on the first component; positioning the ball in the place where the physical mark has been created; and welding the ball in a non-contacting manner to the first component using a laser welding device that is positioned at a distance from the first component and the ball.

### CROSS REFERENCE TO RELATED APPLICATIONS

This application is a continuation of PCT International Application No. PCT/EP2015/068744, filed Aug. 14, 2015, which claims priority under 35 U.S.C. §119 from German Patent Application No. 10 2014 218 968.3, filed Sep. 22, 2014, the entire disclosures of which are herein expressly incorporated by reference.

### BACKGROUND AND SUMMARY OF THE INVENTION

The present invention relates to a method for welding a ball onto a first component and also to a method for connecting two components.

EP 2 475 475 B1, in the name of the applicant, discloses a component connection in which a ball is welded onto a first sheet metal component. The first sheet metal component is connected in a form-fitting manner via the ball to a second component, in which provision is made of a keyhole-shaped through-hole into which the ball projects.

It is an object of the invention to provide a method by which a ball can be welded onto a first component with a high degree of positional accuracy, and also to provide a method in which two components are connected to one another using the welding-on method.

This and other objects are achieved according to the invention by a method for welding a ball onto a first component, the method comprising the following acts: providing a first component; producing a physical mark in or on the first component; positioning the ball at the location at which the physical mark has been produced; and contactlessly welding the ball to the first component via a laser welding device arranged at a distance from the first component and the ball. The object is also achieved by a method for connecting two components using the welding-on method.

The starting point of the invention is a method for welding a ball onto a first component. The ball and/or the first component can be formed, for example, from metal (e.g. steel, aluminum, neodymium or the like). As an alternative thereto, the ball and/or the first component can also be produced from a plastics material, in particular from a plastics material reinforced by fibers (e.g. carbon fibers, glass fibers, etc.).

A central feature of the invention—with a view to achieving a high degree of positional accuracy—is that a “physical mark” is produced in or on the first component. The physical mark is suitable and intended to position a ball to be welded on, i.e. to “center” it at a predefined location, i.e. at the location of the physical mark.

After the physical mark has been produced, the ball is positioned at the location at which the physical mark is provided. On account of the physical mark, the ball is “automatically” positioned in a very precise manner.

The ball is preferably positioned utilizing a magnetic force, i.e. the ball and the first component are “pulled together” by a magnetic force at the location of the physical mark. This has the advantage that there is no need for any clamping apparatus or the like for pressing the ball against the first component. The first component can therefore be arranged as desired in space and the ball only needs to be “placed on”. The ball is then held by the magnetic force. The magnetic force preferably has such a magnitude that the ball can also be applied to the first component from below, with the magnetic force being greater than the weight of the ball.

It is contemplated to use a magnetic ball which attracts the first component. In principle, the first component could also be magnetic and a non-magnetic ball could be used, in which case the first component would attract the ball. It is furthermore contemplated to use a coil which has current flowing through it and generates a magnetic field that “pulls together” the ball with the first component at the location of the physical mark.

Then, the ball is contactlessly welded to the first component. “Contactlessly” means that no welding tongs or the like have to be set directly onto the ball and/or the first component, i.e. welding in a non-contacting manner. Instead, the ball is welded by use of a laser welding apparatus arranged at a distance from the first component and at a distance from the ball.

The invention may at first sight appear to be relatively simple. However, the production of a physical mark in or on the first component is of quite central importance when what is involved, for example in mass production (such as e.g. vehicle body construction), is always positioning a ball precisely relative to a first component, i.e. with a very high degree of accuracy at a predetermined location of the first component. This is of great importance, for example, in vehicle body construction, since in that sector balls acting as connecting elements have to be welded onto components with a high degree of positional accuracy in mass production.

The physical mark can be produced, for example, by use of a forming tool, in particular by use of a deep-drawing tool, with which or in which the first component is formed. In vehicle body construction, vehicle body parts are produced from sheet metal blanks by deep-drawing. If the physical mark is produced during the deep-drawing operation, i.e. in the deep-drawing tool or with the deep-drawing tool or with a “marking tool” (e.g. punching element, die or the like) integrated in the deep-drawing tool, the mark can be produced with a very high degree of accuracy.

By way of example, the physical mark may be a trough-shaped depression. When the ball is placed onto such a trough-shaped depression, it automatically adopts a stable position, i.e. it automatically centers itself, this being similar to the case in which an egg is put in or on an eggcup.

As an alternative to a trough-shaped depression, the physical mark may also be a depression in the form of crosshairs or the like. It is important that the depression is configured in such a way that the ball is “automatically” centered.

As an alternative to a simple trough-shaped depression, the physical mark can also be produced in the manner of an elevation, similar in form to a volcanic crater having a central, trough-like depression. A physical mark of this type is comparable with the shape of some eggcups.

As an alternative or in addition to a trough-shaped depression as has been described above, the physical mark can be produced in the manner of a hole passing through the first component, the diameter of the hole being at least slightly smaller than the diameter of the ball. Even a small hole compared to the ball diameter is sufficient for precisely positioning or for centering the ball.

In particular, the physical mark can be produced in the manner of an elevation like a volcanic crater having a central through-hole. Of course, in this case too, the through-hole has a smaller diameter than the ball.

According to a development of the invention, the laser beam used for welding the ball to the first component is generated by a laser welding device, the laser beam being guided “from one side” into an “undercut region” which is located between the ball and the first component. The “undercut region” is understood to mean a region between an equatorial plane of the ball and the point of contact or the region of contact between the ball and the first component.

In particular, it can be provided that an annular seam extending around the ball is generated with the laser beam.

As an alternative or in addition thereto, it can be provided that the laser welding device generates a laser beam which is directed from a side remote from the ball onto the first component. The thermal energy required for the welding is in this case therefore introduced from the “rear side” of the first component, through the first component, into the region of the point of contact between the ball and the first component, such that the first component and/or the ball locally melt in this region and are welded to one another.

As an alternative or in addition thereto, it can be provided that the laser welding device generates a laser beam which is directed onto a side of the ball which is remote from the first component. During a first phase, ball material is evaporated by way of the laser beam. In this way, a hole extending in the direction of the first component is “burned” into the ball from that side of the ball which is remote from the first component. In a second phase, the ball is then welded to the first component from a base of the hole through the remaining ball material by way of the laser beam penetrating into the hole.

In the method according to the invention for connecting two components, firstly, in accordance with the method described above, a ball is welded onto a first component and then a second component having a through-hole is arranged on the first component in such a way that the ball protrudes into the through-hole or protrudes through the through-hole.

According to a development of the invention, the second component is clamped with its through-hole onto the ball. A clamping connection therefore arises between the through-hole and the ball.

As an alternative or in addition thereto, it can be provided that the second component is connected to the first component by way of a clip element which is clipped onto the ball. In this case, a clamping connection does not necessarily have to be present between the through-hole and the ball. If the clip element projects beyond the through-hole, a form-fitting connection between the first component and the second component can be produced by clipping the clip element onto the ball.

Other objects, advantages and novel features of the present invention will become apparent from the following detailed description of one or more preferred embodiments when considered in conjunction with the accompanying drawings.

### BRIEF DESCRIPTION OF THE DRAWINGS

FIGS. 1 illustrates schematically a method for welding a ball onto a first component according to an exemplary embodiment of the invention.

FIG. 1A schematically illustrates various physical marks formed on a first component in accordance with embodiments of the invention

FIG. 2 illustrates schematically a further method for welding a ball onto a first component.

FIG. 3 illustrates another method for welding a ball onto a first component.

### DETAILED DESCRIPTION OF THE DRAWINGS

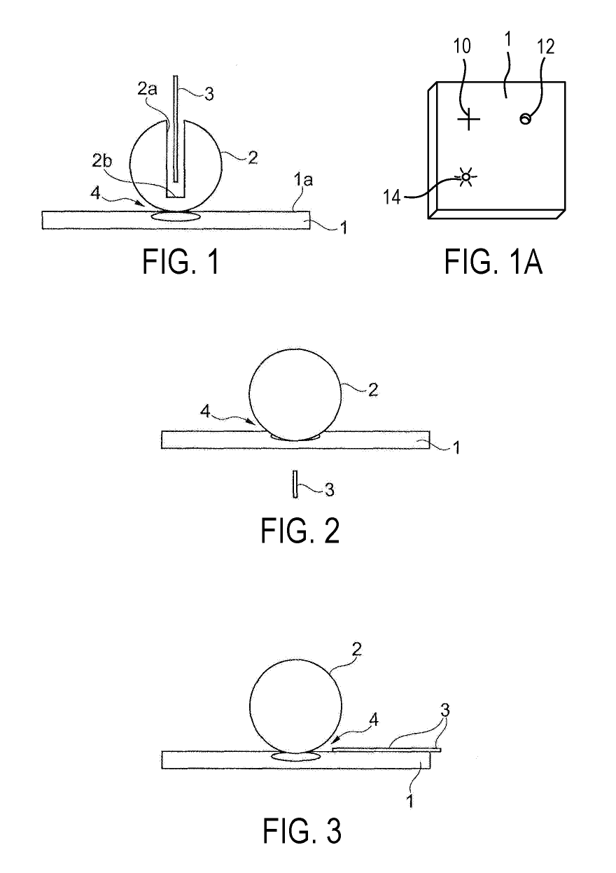

FIG. 1 shows a first component 1, which may be, for example, a steel sheet or an aluminum sheet. A “physical mark” (not identifiable in FIG. 1, see FIG. 1A), e.g. in the form of an imprint in the style of crosshairs 10 or with a spherical segment shape 12, is produced at a predefined location from a top side la of the first component 1. As an alternative to such an imprint, an elevation like a volcanic crater having a central, trough-shaped depression and/or having a central through-hole 14 could also be produced.

After the production of the physical mark, a ball 2 is applied to the top side la of the first component 1. The ball 2 is positioned precisely at the location of the physical mark and is oriented precisely in relation to the first component 1 by the physical mark (self-centering).

If a magnetic force pulling the ball 2 and the first component 1 together is used, the first component can be arranged as desired in space, i.e. the ball 2 can also be applied to the first component from below, for example, without the need for a clamping apparatus or the like which presses the ball 2 against the first component.

In the exemplary embodiment shown in FIG. 1, a laser welding device (not shown specifically here) arranged at a distance from the ball 2 generates a laser beam 3 which is directed onto the ball 2 from a side of the ball 2 remote from the first component 1 and evaporates ball material, such that a hole 2a extending in the direction of the first component 1 is formed in the ball 2.

After the hole 2 has been produced, welding is carried out by means of the laser beam 3 from a base 2b of the hole 2a through the remaining ball material, i.e. the ball 2 and/or the first component 1 are locally melted in a region of contact 4 and are welded to one another.

FIG. 2 shows an exemplary embodiment in which a physical mark has been produced in a quite similar manner before the ball 2 was placed onto the component 1. A laser welding device (not shown specifically here) generates a laser beam 3 which is directed from a side remote from the ball 2 onto the first component 1. The laser beam 3 is therefore directed onto the first component 1 from the “rear side” of the first component. In this process, thermal energy is supplied through the first component 1 in the region of contact 4. This leads to local fusion of the ball 2 with the first component 1.

If the physical mark can also be identified from the rear side of the first component 1 remote from the ball 2 or can be detected by an optoelectronic device, the location or position of the physical mark can also be used for orienting the laser beam 3 with positional accuracy.

In the exemplary embodiment shown in FIG. 3, a physical mark is likewise produced, as described above, before the ball 2 is placed onto the first component 1. Then, a laser beam 3 is guided from one side into an undercut region located between the ball 2 and the first component 1, i.e. into the region of contact 4. By virtue of the fact that the laser beam 3 is “guided around” the ball, an annular seam extending around the ball 2 can be generated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for welding a ball onto a first component, said method comprising the acts of:
providing a first component;
producing a physical mark in or on the first component;
positioning the ball at a location at which the physical mark has been produced;
contactlessly welding the ball to the first component via a laser welding device arranged at a distance from the first component and the ball.

2. The method according to claim 1, wherein the act of producing the physical mark is carried out by a forming tool by which the first component is formed.

3. The method according to claim 2, wherein the forming tool is a deep-drawing tool.

4. The method according to claim 1, wherein the physical mark is a trough-shaped depression.

5. The method according to claim 1, wherein the physical mark is an elevation of the first component having a central-trough-shaped depression.

6. The method according to claim 1, wherein the physical mark is a hole passing through the first component.

7. The method according to claim 1, wherein the physical mark is an elevation of the first component having a central through-hole.

8. The method according to claim 1, wherein the act of contactlessly welding the ball further comprises the acts of:
generating a laser beam; and
guiding the laser beam from one side in an undercut region, the undercut region being located between the ball and the first component in which the ball touches the first component.

9. The method according to claim 8, wherein an annular seam extending around the ball is generated with the laser beam.

10. The method according to claim 1, wherein the act of contactlessly welding the ball further comprises the acts of:
generating a laser beam; and
directing the laser beam from a side remote from the ball onto the first component such that the first component and/or the ball locally melts.

11. The method according to claim 1, wherein the act of contactlessly welding the ball further comprises the acts of:
generating a laser beam; and
directing the laser beam onto a side of the ball which is remote from the first component.

12. The method according to claim 11, wherein, in a first phase, material of the ball is evaporated via the laser beam such that a hole is formed in the ball extending in a direction toward the first component.

13. The method according to claim 12, wherein, in a second phase, the ball is welded to the first component from a base of the hole through a remaining ball material via the laser beam penetrating into the hole.

14. A method for connecting first and second components, the method comprising the acts of:
first, welding a ball onto a first component according to the method of claim 1; and
second, arranging a second component having a through-hole on the first component such that the ball welded onto the first component protrudes into the through-hole or through the through-hole of the second component.

15. The method according to claim 14, wherein the second component is clamped via the through-hole onto the ball of the first component.

16. The method according to claim 14, wherein a clip element is clipped onto the ball and projects beyond the through-hole in order to connect the second component to the first component.

17. The method according to claim 1, further comprising the act of:
magnetically attracting together the ball and the first component at a location of the physical mark.

18. The method according to claim 17, wherein the ball is a magnetic ball.

19. A component having a welded-on ball produced by the method of claim 1.

20. A component connection produced by the method of claim 14.
